(19) United States
(12) Patent Application Publication
(10) Pub. No.: US 2010/0065565 A1
(43) Pub. Date: Mar. 18, 2010

(54) GRADUAL RELEASE PRESSURIZING VALVE FOR FLUID STORAGE TANK BREATHER AND BREATHER INCLUDING SAME

(75) Inventors: Bruce E. Knuth, Oconomowoc, WI (US); Robert E. Broman, Mequon, WI (US)

Correspondence Address: REINHART BOERNER VAN DEUREN P.C., 2215 PERRYGREEN WAY, ROCKFORD, IL, 61107, US

(73) Assignee: Helgesen Design Services, LLC, Hartford, WI (US)

(21) Appl. No.: 12/562,592

(22) Filed: Sep. 18, 2009

Related U.S. Application Data
(60) Provisional application No. 61/098,079, filed on Sep. 18, 2008.

(51) Int. Cl. B65D 90/32; F16K 1/52

(52) U.S. Cl. 220/89.1; 251/205; 251/336

(57) ABSTRACT

A breather for a fluid storage tank, a storage tank incorporating same, and a method of releasing pressure in a fluid storage tank is provided. The present invention permits graduated release of pressure within the storage tank by allowing for varied flow rates of air out of the storage tank. In one embodiment, a valve assembly is provided that includes a valve member that has a graduated release feature that adjusts the size of a gap though the valve assembly formed between the valve member and a corresponding valve seat.

### CROSS-REFERENCE TO RELATED PATENT APPLICATIONS

This patent application claims the benefit of U.S. Provisional Patent Application No. 61/098,079, filed Sep. 18, 2008, the disclosure and teachings of which are incorporated herein, in their entireties, by reference thereto.

### FIELD OF THE INVENTION

This invention generally relates to fluid storage tanks, and more particularly to breathers for fluid storage tanks.

### BACKGROUND OF THE INVENTION

Besides the working fluid held within a fluid storage tank, fluid storage tanks also include a volume of air, or buffer. As fluid is continuously drawn from and added to the storage tank as it is cycled through a connected system, for example a hydraulic system, the internal tank pressure within the fluid storage tank can fluctuate creating vacuums and/or high-pressure states within the fluid storage tank. These fluctuations of the internal tank pressure are undesirable. If the internal tank pressure drops significantly such that a vacuum is created, the fluid storage tank may be susceptible to collapse. Alternatively, if internal tank pressure is too high within the fluid storage tank, the operation of a downstream system, such as a hydraulic system, can be affected.

Therefore, many fluid storage tanks include a breather assembly. The breather assembly (also referred to generically as a breather) typically regulates internal tank pressure. Preferably, the breather regulates both high-pressure or low-pressure within the tank. The breather allows atmospheric air to enter the tank in the event that internal tank pressure drops too low or enters a vacuum state. Alternatively, the breather allows internal tank air to exit through the breather into the surrounding atmosphere in the event that internal tank pressure rises too significantly.

While the use of a breather is beneficial with regard to regulating internal tank pressure, due to humidity within the atmospheric air, it is desirable to reduce the amount of air that is transferred into the storage tank. When humid air enters the storage tank, future changes in environmental conditions such as temperature can result in undesirable condensation and potentially icing within the fluid storage tank.

Therefore, many tanks are pressurized to a preset level to attempt to reduce the number of cycles that approach the vacuum state. More particularly, many tanks are pre-pressurized to a range of between about one PSI and five PSI. This preset pressurization of the fluid storage tank reduces the amount of atmospheric air that is transferred into the tank by reducing the likelihood that the tank will enter a vacuum state. By reducing the amount of air transferred into the tank, the amount of airborne water vapor in the form of humidity is reduced. This can significantly reduce the amount of condensation that may form within the tank due to changes in temperature.

One problem with pressurizing valves for current breather arrangements is that the valves typically only operate on an open or closed condition and do not allow for varying or adjusting the flow rate of air into or out of the storage tank. Thus, this results in significant spikes in the flow rate of air into or out of the storage tank, which can again affect the consistency of the operation of the downstream system. When a high-pressure state is reached within the storage tank, the valve will operate rapidly and allow a significant amount of air to exit the storage tank. Beyond potential affects to downstream systems, the spike configurations can often result in excessive amounts of air exiting the storage tank and the internal tank pressure will overshoot the desired internal storage tank pressure.

The present invention relates to improvements over the current state of the storage tank art and particularly storage tanks that include tank breathers.

### BRIEF SUMMARY OF THE INVENTION

The present invention provides for improved pressure release of a fluid storage tank by releasing buffer air from within the storage tank.

In one embodiment, a breather assembly is provided that includes a valve assembly. The valve assembly includes a valve seat defining a fluid flow path. The valve assembly also includes a valve member inter acting with the valve seat for opening and closing the fluid flow path. The valve member includes a graduated release feature for adjusting a size of a gap formed between the valve member and the valve seat as the valve member transitions between a closed position and a fully open position relative to the valve seat.

In one more particular embodiment, the fluid flow path includes a cylindrical portion in which the valve member is received in the closed position. The valve member is axially slidable within the cylindrical portion between the closed position and the open position. In a more particular embodiment, the valve member includes a generally cylindrical portion that is received within the valve seat, and the cylindrical portion includes the graduated release feature. Further yet, in one embodiment, the graduated release feature is provided by a wedge shaped void removed from the cylindrical portion of the valve member. In another alternative embodiment, the graduated release feature is a plurality of different grooves having different lengths that only open depending on varied relative axial positions of the valve member relative to the valve seat. In even further embodiments, the graduated release feature is provided by a single groove having a varied radius depending on the axial location of the groove along the valve member. These graduated release features are typically formed in the outer surface of the valve member.

In another embodiment, a method of releasing pressure within a fluid storage tank is provided. The method includes gradually adjusting the rate at which air is permitted to exit the fluid storage tank to the ambient.

In a preferred implementation of the method the step of gradually adjusting the rate includes gradually increasing the rate at which air is permitted to exit the fluid storage tank from an initial flow rate to a fully open flow rate. In a further implementation of the method, the step of gradually adjusting the rate includes gradually increasing the size of a gap between a valve member and a valve seat.

Further yet, an embodiment of the present invention includes a fluid storage tank for storing a fluid that also includes a buffer zone of air above the fluid. The fluid storage tank includes a tank and a breather. The breather includes a valve assembly that permits air to exit the tank. The valve assembly includes a valve seat that interacts with a valve member. The valve seat defining a fluid flow path. The valve member interacts with the valve seat for opening and closing the fluid flow path. The valve member includes a graduated release feature for adjusting a size of a gap formed between the valve member and the valve seat as the valve member transitions between a closed position and a fully open position relative to the valve seat.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a tank including a breather arrangement according to the teachings of the present invention;

FIG. 2 is a simplified isometric illustration of the breather arrangement of FIG. 1 having the cover portion removed to illustrate the filter and pressurizing valve;

FIG. 3 is a simplified perspective illustration of a pressurizing valve of the breather arrangement of FIG. 1;

FIGS. 4 and 5 are isometric illustrations of the valve member of the pressurizing valve of FIG. 3;

FIGS. 6 and 7 illustrate the valve member in a low flow rate orientation typically as the result of a small variation of internal tank pressure from a desired value;

FIGS. 8 and 9 illustrate the valve member in a large flow rate orientation typically as the result of a large variation of internal tank pressure from a desired value;

FIG. 10 illustrates the valve seat of the pressurizing valve of FIG. 3; and

FIG. 11 is a profile illustration of the valve member of the pressurization valve assembly of FIG. 3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

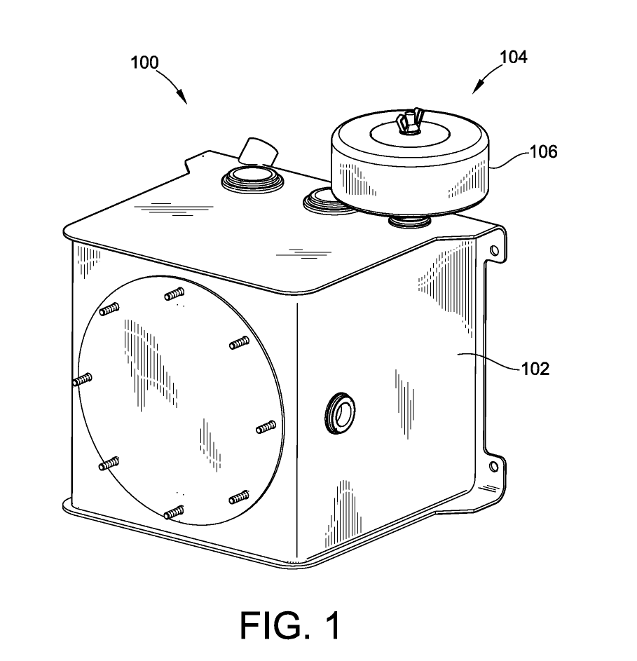

FIG. 1 illustrates a storage tank assembly 100. The storage tank assembly 100 includes a storage tank 102 (also referred to as a reservoir or simply a tank) as well as a breather assembly 104. The breather assembly 104 (also referred to as breather arrangement 104) is mounted to the top of the storage tank 102. The storage tank 102 functions to hold fluid that is to be used by a downstream system (not shown). One example of such a system is a hydraulic system where fluid is drawn from the tank circulated through the system and then returned to the tank. While the tank primarily holds fluid for use in the downstream system, the tank will also include a portion of air within the tank to allow for operational fluctuations in the system which will ultimately result in fluctuations of internal tank pressure as well as the volume of fluid stored within the tank 102.

Because the internal pressure of the storage tank 102 may fluctuate, the breather assembly 104 functions to regulate the internal pressure of the storage tank 102 above a predetermined internal pressure value and below a predetermined pressure value.

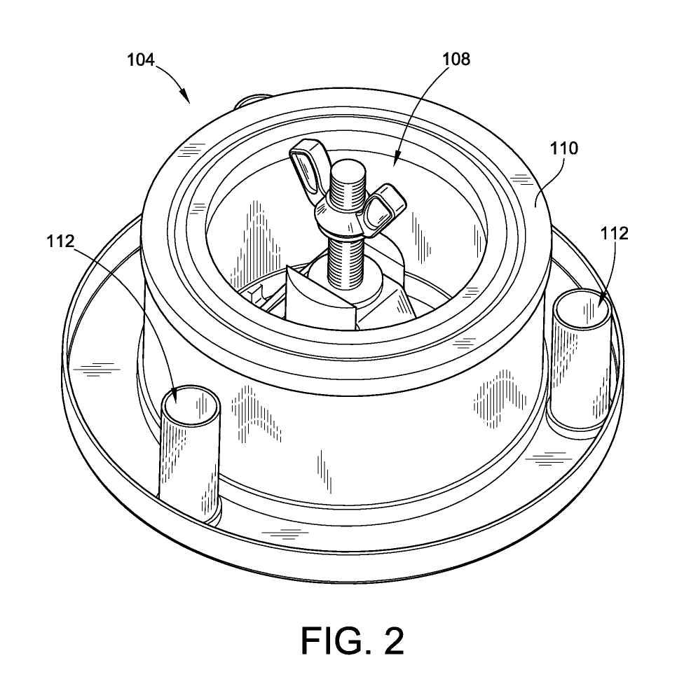

Now that a general environment of the breather is identified, the features of the breather assembly 104 will be more fully described. FIG. 2 illustrates the breather assembly with the cover 106 removed. The breather assembly 104 generally includes a pressurizing valve 108, and a filter 110. With cover removed, a plurality of air inlet ports 112 are exposed that allow to enter and exit the breather assembly 104. The filter 110 prevents particulates within atmospheric air from passing into the storage tank 102 and contaminating any fluid stored therein.

The pressurizing valve assembly 108 is used to regulate the internal pressure of the storage tank 102. More particularly, the pressurizing valve assembly 108 is the device that is used to maintain the internal pressure of the storage tank assembly 100 within the desired range identified previously. To regulate the pressure, the pressuring valve assembly 108 generally includes two separately-acting valve assemblies that operate to allow for one way flow of air into the tank and another one way flow of air out of the storage tank 102.

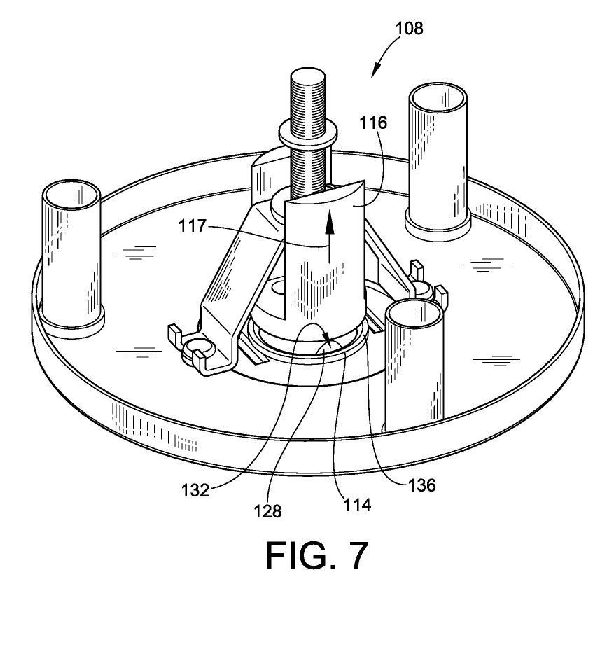

A first valve assembly of the pressurization valve assembly 108 is a high-pressure valve assembly that generally includes a valve seat member 114 and a spring loaded high-pressure valve member 116. The spring loaded valve member 116 interacts with the valve seat member 114 to regulate the flow of air out of the storage tank 102 in the event that the pressure within the storage tank 102 exceeds a predetermined value. The valve member 116 is spring loaded or biased towards the valve seat member 114 in a standard or normal state such that fluid is not permitted to pass between the valve member 116 or the valve seat member 114. However, when the pressure within the storage tank exceeds the desired internal tank pressure, the valve member 116 will compress a spring behind mounting bracket 120 and move axially away from the valve seat member 114, as illustrated by arrow 117. The movement of valve member 116 relative to seat member 114 will create an opening or gap 132 (See FIGS. 7 and 9) between the two structures and allow air from within the storage tank 102 to exit therefrom through a fluid flow path operably communicating the ambient environment surrounding storage tank 102 with the internal cavity of tank 102.

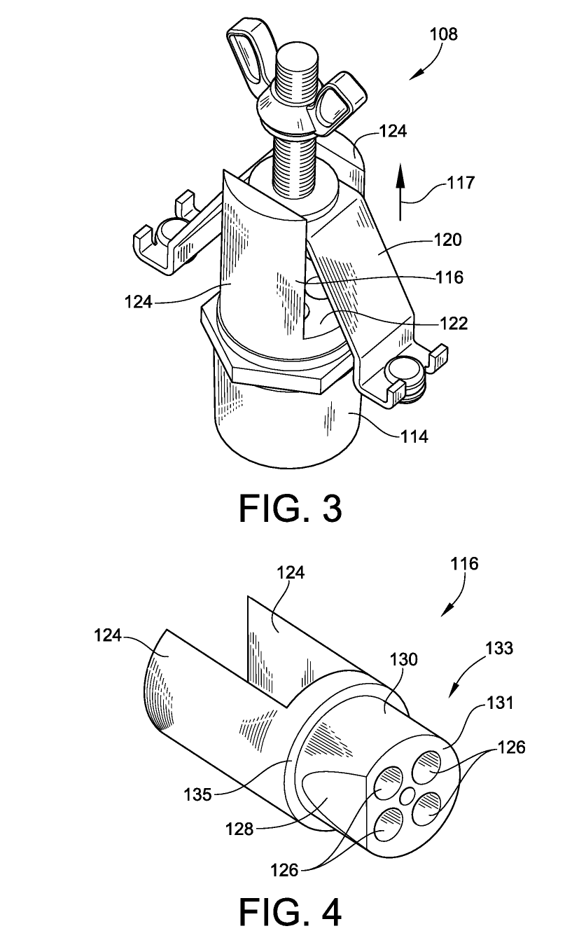

Returning to FIG. 3, the spring is typically biased between mounting bracket 120 and an abutment surface 122 of the valve member 116. The spring is typically located between the two wing portion 124 of the valve member 116. The preload of this spring can be adjust to adjust the internal tank pressure at which the valve member 116 will begin to actuate along arrow 117.

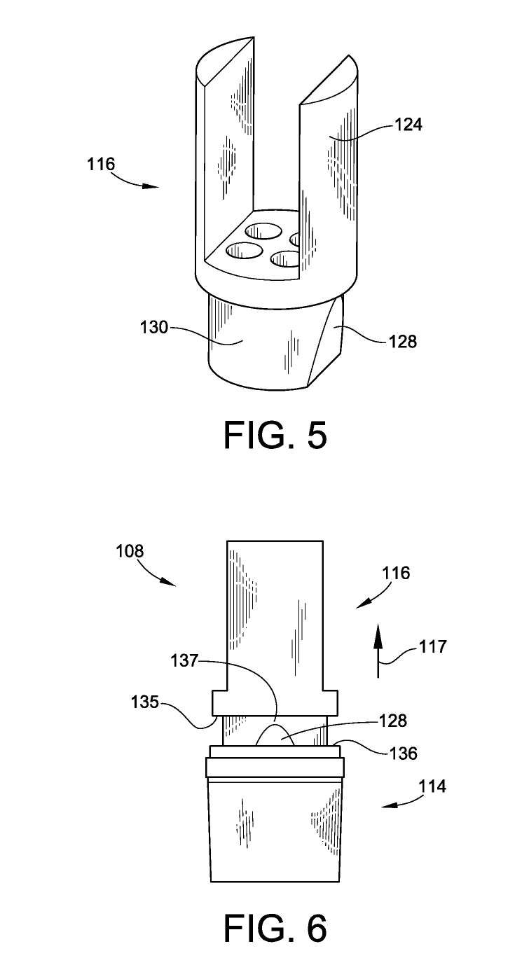

FIGS. 4 and 5 illustrate the valve member in a perspective illustration. Valve member 116 includes a plurality of low-pressure ports 126 that regulate the internal pressure of the storage tank 102 when it drops below a desired pressure, typically, when the tank 102 enters a state of vacuum. The low-pressure ports 126 interact with a low-pressure valve member, typically in the form of a valve flapper 127 that will open when the pressure external to the valve member 116 such as the atmospheric pressure, becomes greater than the pressure within the storage tank to permit air to flow through the low-pressure port 126. The low-pressure ports 126 and low-pressure valve member define a second valve assembly of the pressuring valve assembly 108. While valve member 116 defines low-pressure ports 126, the two valve assemblies (i.e. high and low-pressure) operate separately.

Additionally, valve member 116 is configured to provide gradual release of the high-pressure internal tank pressure through the pressurization valve assembly 108. To effectuate the gradual release, the valve member 116 includes a graduated release feature 128. The graduated release feature 128 in the illustrated embodiment is formed in an outer surface 130 of a cylindrical plug portion 133 of the body of the valve member 116. In the illustrated embodiment, graduated release feature 128 is merely a cut-out or section of the valve cylindrical portion of the body of the valve member 116 that is removed. To effectuate the gradual release, the graduated release feature 128 varies the outer periphery of the valve member 116 from a cylindrical surface and creates a void therein. The graduated release feature is in the form of a planar surface that intersects both the outer surface 130 and a distal end 131 of the cylindrical plug portion 133.

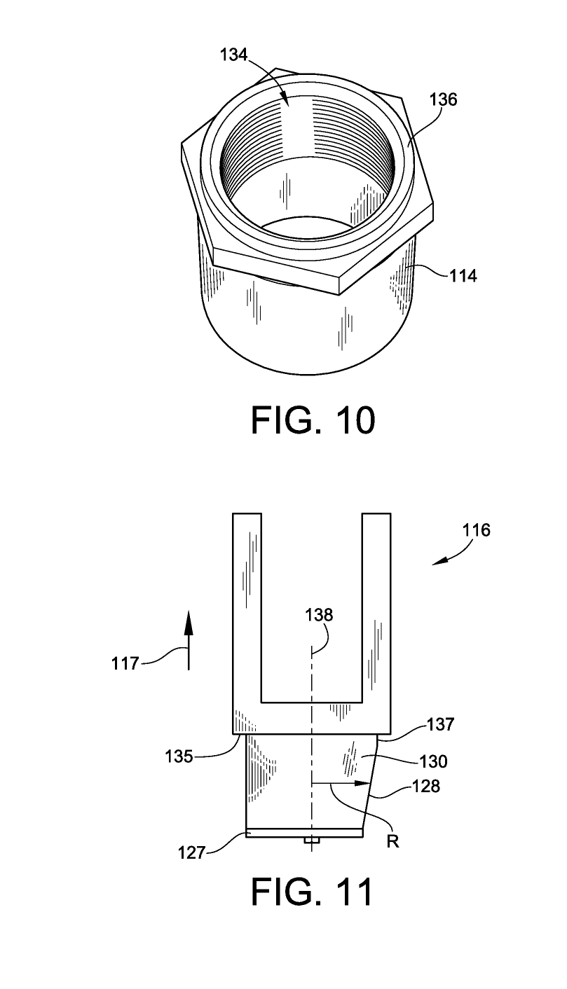

With reference to FIGS. 6 and 7, as the valve member 116 is moved to an open position relative to valve seat member 114 (i.e. the valve member 116 moves axially along arrow 117 away from valve seat member 114), gap 132 is formed between the valve member 116 and the valve seat member 114. This gap 132 permits air to pass through the valve seat member 114 and exit the storage tank 102. More particularly, the cavity 134 defined by the valve seat member 114 (see FIG. 10) is opened and permitted to fluidly communicate the interior of the tank 102 with the surrounding ambient.

This cavity 134 slideably receives valve member 116 axially therein. The diameters of the cylindrical plug portion 133 of valve member 116 that includes the graduated release feature 128 and the inner diameter of cavity 134 are closely sized to eliminate or substantially eliminate airflow therebetween. Thus, when the valve member 116 begins to move relative to valve seat 114, the only pressure release is primarily facilitated by the graduated release feature 128 rather than any clearance between the outer surface 130 of the cylindrical plug portion 133 and the inner surface of cavity 134.

In the closed position, the valve member 116 will typically include a stepped region 135 that axially presses against end 136 of the valve seat 114 to effectuate an axial seal arrangement to prevent leakage in a standard or normal state. Also, the relative dimensions of the cylindrical plug portion 133 of the valve member 116 is sized to permit sliding of the valve member 116 relative to valve seat 114. The cylindrical plug portion 133 also includes a completely cylindrical section 137 between the graduated release feature 138 and stepped region 135 that, when inserted into cavity 134 closes or substantially closes the fluid path between the ambient and the tank 102 even if the stepped region 135 is not abutted against end 136. As such, the outer diameter of cylindrical section 137 is closely sized to the inner diameter of cavity 134.

As illustrated in FIGS. 4, 5 and 11, the graduated release feature 128 has a varied profile, for instance, the graduated release feature 128 has a tapered surface that varies in radius R relative to a central axis 138 of valve member 116. Thus, as the valve member 116 is biased axially out of the valve member seat 114 (such as along arrow 117), the size of the gap 132 between valve member 116 and valve seat member 114 varies.

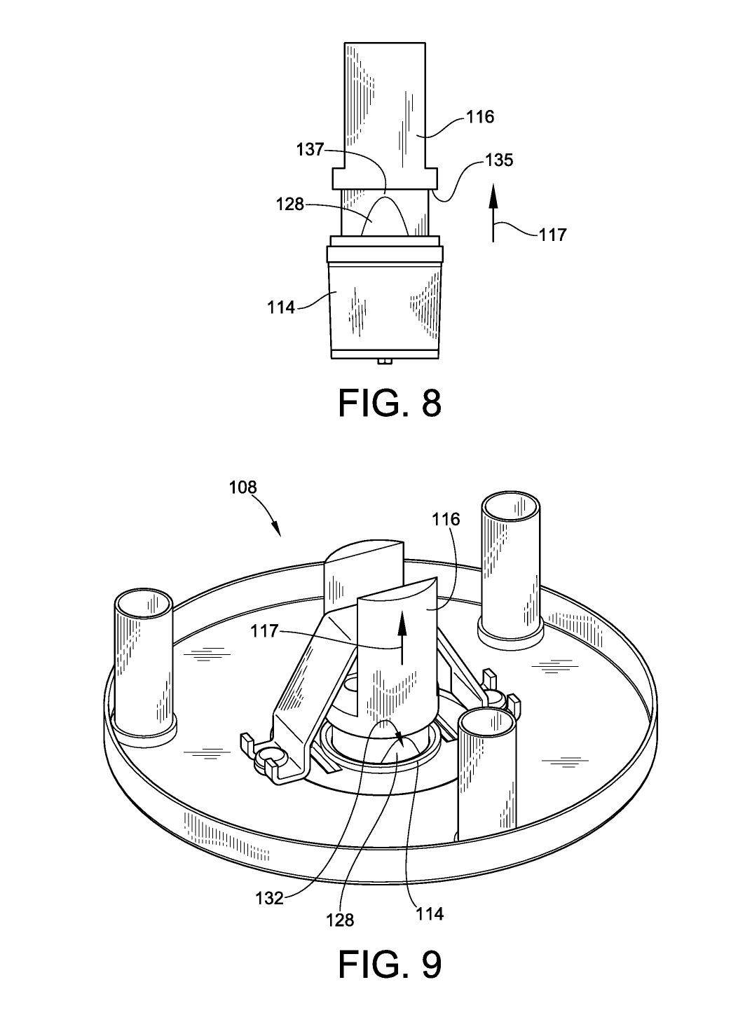

This varied configuration of the graduated release feature 128 provides for a variable and gradual release of pressure from the storage tank 102. The gradual release acts such that if the valve member 116 is only biased out of the valve seat 114 a small amount, (e.g. only when a small pressure differential is provided) only a small gap 132 is formed between the valve seat member 114 and valve member 116 allowing for only a small amount of airflow therethrough (see FIGS. 6 and 7). Alternatively, if the valve member 116 is biased a significant distance out of the valve seat member 114, (e.g. when a large pressure differential is provided) a large gap 132 is formed therebetween by the graduated release feature 128 (see FIGS. 8 and 9). In the small configuration, only a slower release of air is permitted. In the larger orientation, a faster amount of air can exit the storage tank 102.

Thus, when only a small pressure drop is desired, the present arrangement permits for only a small amount of air to be allowed to escape. This is permitted because with a small pressure differential above the desired pressure within the storage tank that needs to be alleviated, the valve member will only be biased a small amount do to the small force acting on the valve member thereby resulting in a small gap 132. This is opposed to prior arrangements where the valve was either open or closed (with no in-between or graduated positions) where the valve would be wide open and allow for tank pressure overshoot to too low of an internal tank pressure.

Further, even if a large variation from the desired high-pressure value is experienced within the tank, when the valve member begins to transition from the closed state (see FIG. 3) to the wide open state (see FIGS. 8 and 9), the pressurization valve assembly 108 does not instantly go from closed to wide open, or visa-versa when going from open to closed. Instead, the size of the gap 132 experiences a graduated opening as it approaches the wide-open position thereby reducing flow rate spikes (i.e. no flow rate to max flow rate) upon opening of the pressurization valve assembly 108.

While the present invention is shown to including a graduated release feature 128 that is a single cut out void in the outer periphery of the valve member 116, the graduated release feature 128 could be other structures to effectuate variation in gap 132. For instance, the valve member could include a plurality of different length grooves that extend different axial lengths along the valve member 116. Thus, when the valve member 116 is actuated a further distance out of the valve seat 114, more and more grooves are exposed external to valve seat 114 to increase the effective size of gap 132, which would actually be formed by a plurality of grooves. Alternatively, the graduated release feature 128 could be a single groove that varies in radial depth the farther the valve member 116 is removed from valve seat 114. Additional methods of providing a graduated release feature 128 could be implemented. For example, instead of a single tapered cut-out, as illustrated in FIGS. 4 and 5, a plurality of cut-outs could be implemented or a stepped arrangement could be provided.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid storage tank assembly for storing a fluid that also includes a buffer zone of air above the fluid comprising:
a tank; and
a breather, the breather including a high-pressure valve assembly that permits air to exit the tank, the high-pressure valve assembly including:
a valve seat defining a first fluid flow path operably communicating the ambient environment surrounding the tank with an internal cavity of the tank; and
a high-pressure valve member interacting with the valve seat for opening and closing the fluid flow path, the high-pressure valve member including a graduated release feature for adjusting a size of a first gap formed between the high-pressure valve member and the valve seat as the high-pressure valve member transitions between a closed position and a fully open position relative to the valve seat.

2. The fluid storage tank assembly of claim 1, wherein the first fluid flow path includes a cylindrical seat portion in which the valve member is axially received, the high-pressure valve member axially slidable within the cylindrical seat portion between the closed position and the open position to adjust a size of the first gap.

3. The fluid storage tank assembly of claim 2, wherein the high-pressure valve member includes a generally cylindrical plug portion that is received within the valve seat, the cylindrical plug portion including the graduated release feature.

4. The fluid storage tank assembly of claim 3, wherein the graduated release feature is a tapered surface formed in the periphery of the cylindrical plug portion such that as the axial position of the tapered surface of the high-pressure valve member within the cylindrical seat portion changes, the first gap being defined between the graduated release feature and the cylindrical seat portion changes, such that as the high-pressure valve member transitions toward the fully open position, the opening increases.

5. The fluid storage tank assembly of claim 4, wherein the tapered surface is generally planar and intersects a distal end of the cylindrical plug portion at a first intersection as well as the cylindrical surface of the cylindrical plug portion at a second intersection, the tapered surface tapering increasingly radially inward in the direction extending from the second intersection toward the first intersection.

6. The fluid storage tank assembly of claim 5, wherein the cylindrical plug portion includes a cylindrical section that has a complete circular cross-section proximate the second intersection, the outer diameter of the cylindrical section matched to the inner diameter of the cylindrical seat portion, the closed position defined when the cylindrical section is received in the cylindrical seat portion.

7. The fluid storage tank assembly of claim 6, wherein the high-pressure valve member includes a stepped portion, the cylindrical section axially interposed between the stepped portion and the tapered surface, the stepped portion defining a stop feature having at least one dimension greater than the inner diameter of the cylindrical seat portion that abuts the cylindrical seat portion in the closed position to limit the degree of axial insertion of the high-pressure valve member into the cylindrical seat portion.

8. The fluid storage tank assembly of claim 7, further comprising a low-pressure valve assembly including a low-pressure port extending axially through the high-pressure valve member providing a second flow path between the ambient surrounding the tank and the internal cavity of the tank, the low-pressure valve assembly further including a low-pressure valve member operably interacting with the low-pressure port to transition between an open position to permit fluid to flow into the internal cavity when the ambient is at a higher pressure than the internal cavity and a closed position to prevent fluid from flowing into or out of the internal cavity when the ambient is at a lower pressure than the internal cavity.

9. The fluid storage tank assembly of claim 8, wherein the low-pressure valve member interacts with the distal end of the high-pressure valve member to seal off the second flow path in the closed position of the low-pressure valve assembly.

10. The fluid storage tank assembly of claim 9, wherein the low-pressure valve member is a flexible disk directly mounted to the distal end, the flexible disk flexing between the open and closed positions of the low-pressure valve assembly.

11. The fluid storage tank assembly of claim 7, further comprising a biasing member biasing the high-pressure valve member into the cylindrical seat portion toward the closed position.

12. The fluid storage tank assembly of claim 7, wherein the high-pressure valve member remains axially inserted, at least partially, in the cylindrical seat portion when the high-pressure valve assembly is in the fully open position.

13. The fluid storage tank assembly of claim 1, further comprising a low-pressure valve assembly including a low-pressure port extending axially through the high-pressure valve member providing a second flow path between the ambient surrounding the tank and the internal cavity of the tank, the low-pressure valve assembly further including a low-pressure valve member operably interacting with the low-pressure port to transition between an open position to permit fluid to flow into the internal cavity when the ambient is at a higher pressure than the internal cavity and a closed position to prevent fluid from flowing into or out of the internal cavity when the ambient is at a lower pressure than the internal cavity.

14. The fluid storage tank assembly of claim 13, wherein the low-pressure valve member interacts with a distal end of the high-pressure valve member to seal off the second flow path in the closed position of the low-pressure valve assembly.

15. The fluid storage tank assembly of claim 14, wherein the low-pressure valve member is a flexible disk directly mounted to the distal end, the flexible disk flexing between the open and closed positions of the low-pressure valve assembly.

16. The fluid storage tank of claim 11, wherein the valve member further includes a pair of wing portions spaced apart from one another forming a gap therebetween, the biasing member being interposed between the pair of wing portions within the gap.
